(19) United States
(12) Patent Application Publication
(10) Pub. No.: US 2004/0172578 A1
(43) Pub. Date: Sep. 2, 2004

(54) Method and system of operating system recovery

(75) Inventors: Liang-Chi Chen, Shijr City (TW); Wei Lin, Shijr City (TW)

Correspondence Address: LADAS & PARRY, 5670 WILSHIRE BOULEVARD, SUITE 2100, LOS ANGELES, CA, 90036-5679, US

(73) Assignee: Acer Inc.

(21) Appl. No.: 10/438,416

(22) Filed: May 13, 2003

(30) Foreign Application Priority Data
Feb. 27, 2003 (TW) 92104182

(51) Int. Cl. H04B 1/74

(52) U.S. Cl. 714/15

(57) ABSTRACT

A system and method of operating system recovery in a computer system. First, a recovery button on the computer system triggers the BIOS to enable the computer system to reboot to a second disk partition, and execute a recovery system in the second disk partition to recover the original operating system by an image file in the second disk partition which is an image copy of the original operating system. Another embodiment of the present invention enables operating system recovery in a computer system coupled with a server system through a network. The computer system instructs the BIOS to enable the computer system to reboot from a second disk partition in response to a recovery instruction received from the server system, and recovers the original operating system by the image file directly.

### BACKGROUND OF THE INVENTION

1. Field of the Invention

The present invention relates to a method and system of operating system recovery, and particularly to a method and system that recovers the operating system of a computer system by local operations or a remote server system through a network.

2. Description of the Related Art

During the production of a computer system, the manufacturer usually installs an operating system (OS) in a data storage device, such as the hard disk of the computer system. The operating system includes related hardware device drivers and applications. The manufacturer generally installs an OS image file in the hard disk of the computer system, and the computer system will unpack the OS image file in the hard disk to pre-setup the operating system when users first power on the computer system.

Usually, a system disc (SCD) and a recovery disc (RCD) are accompanied with the computer system provided to users. The system disc includes patch files, applications and drivers. The recovery disc includes bootable files and an OS image file. When the hardware device drivers and applications of the computer system are to be updated, the manufacturer places the patch files (updated files) into the system disc. Therefore, users may use the system disc to update corresponding hardware device drivers and applications.

When the computer system encounters the problem of malfunction or failure, users may use the recovery disc to restore the operating system to its initial status. However, if users lose the recovery disc or the CD-ROM drive cannot read the data in the recovery disc to restore the operating system, the recovery of the operation of the computer system cannot be accomplished.

Further, since the recovery operation must be performed by an operator at the local side, the recovery operation is time-consuming and inefficient for an enterprise having many computer systems that are bound to be updated frequently.

### SUMMARY OF THE INVENTION

It is therefore an object of the present invention to provide a method and system that recovers the operating system of a computer system by a recovery button installed on the computer system.

Another object of the present invention is to provide a method and system that recovers the operating system of a computer system by a remote server system through a network.

To achieve the above object, the present invention provides a method of operating system recovery for use in a computer system. First, a recovery button is installed on the computer system. In response to the trigger of the recovery button, the BIOS (Basic Input/Output System) of the computer system is enabled to reboot the computer system to a second disk partition, and executes a recovery system in the second disk partition to recover the operating system in a first disk partition by an image copy of the operating system in the second disk partition.

According to another embodiment, a method of operating system recovery for use in a computer system coupled with a server system through a network is provided. The computer system receives a recovery instruction from the server system through the network, and enables the BIOS to reboot the computer system to a second disk partition, and recover the operating system in a first disk partition directly by an image copy of the operating system in the second disk partition.

### BRIEF DESCRIPTION OF THE DRAWINGS

The aforementioned objects, features and advantages of the present invention will become apparent by referring to the following detailed description of the preferred embodiment with reference to the accompanying drawings, wherein:

FIG. 1 is a schematic diagram illustrating the architecture of the system of operating system recovery according to a first embodiment of the present invention;

FIG. 2 is a flowchart showing the trigger process of the method of operating system recovery according to the first embodiment of the present invention;

FIG. 3 is a schematic diagram illustrating the architecture of the system of operating system recovery according to a second embodiment of the present invention;

FIG. 4 is a flowchart showing the trigger process of the method of operating system recovery according to the second embodiment of the present invention; and

FIG. 5 is a flowchart showing the boot process according to the present invention.

### DETAILED DESCRIPTION OF THE INVENTION

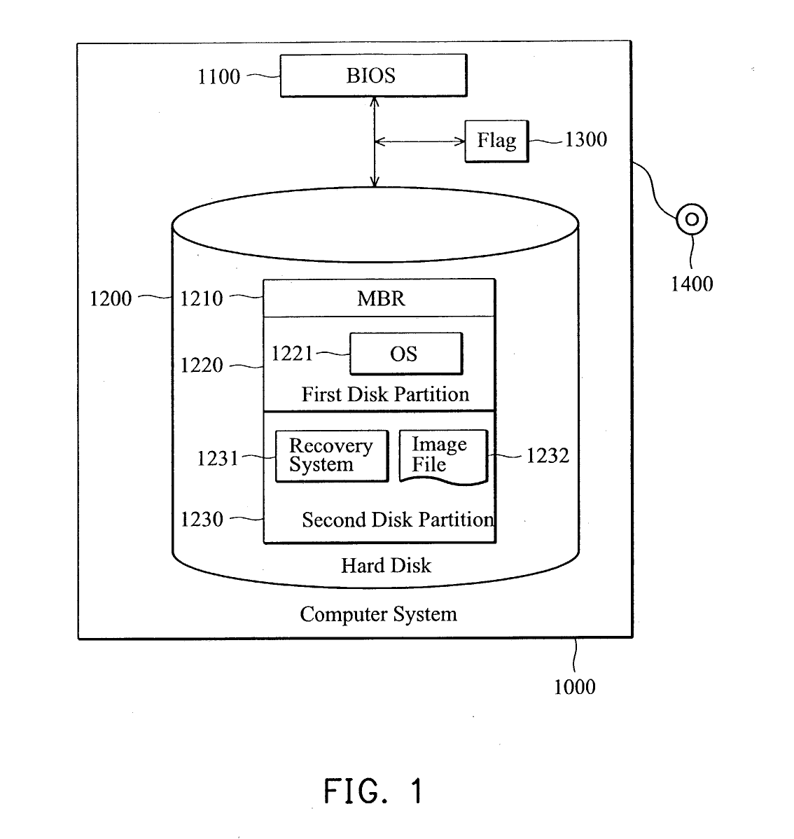

FIG. 1 illustrates the architecture of the system of operating system recovery according to a first embodiment of the present invention. The system of operating system recovery according to the first embodiment of the present invention is suitable for use in a computer system 1000. The system includes a BIOS (Basic Input/Output System) 1100, a hard disk 1200, a flag 1300 and a recovery button 1400.

The BIOS 1100 is a firmware code product stored in a ROM (Read Only Memory) on the motherboard of the computer system 1000, and provides several functions, such as accommodating basic input and output functions, setting system configurations, and performing hardware tests.

The hard disk 1200 includes a MBR (Master Boot Record) 1210, a first disk partition 1220 and a second disk partition 1230. The MBR 1210 is the first sector of the first cylinder in the hard disk 1200. The MBR 1210 stores a master boot program and a master partition table recording the start address and end address of each partition. The master boot program can search the booting sector of the bootable partition in the master partition table, and boot the computer system 1000.

The first disk partition 1220 is a default bootable partition of the computer system 1000. The first disk partition 1220 includes an original copy of an operating system 1221. In general, the second disk partition 1230 is an unknown partition to the operating system 1221, and includes a recovery system 1231 and an image file 1232 which is an image copy of the operating system 1221. Users can operate the recovery system 1231 to unpack the image file 1232 to recover the operating system 1221 in the first disk partition 1220.

The flag 1300 may be implemented by hardware, such as a register or implemented using software. The flag 1300 stores a booting mode of the computer system 1000, which will be discussed later in detail. The recovery button is opereable through a GPIO (General Purpose Input/Output) interface, and installed on the computer system 1000. Since most processing units and related chipsets will reserve several GPIO pins for use by peripheral applications, the implementation of the recovery button via a GPIO pin is the most straightforward approach to fulfill the demand of obtaining an user interface for a local operator to invoke system recovery event, however, the implementation of the recovery button is not intended to limited to such means. In response to the trigger of the recovery button, the BIOS 1100 of the computer system 1000 can perform related logic determination or operations.

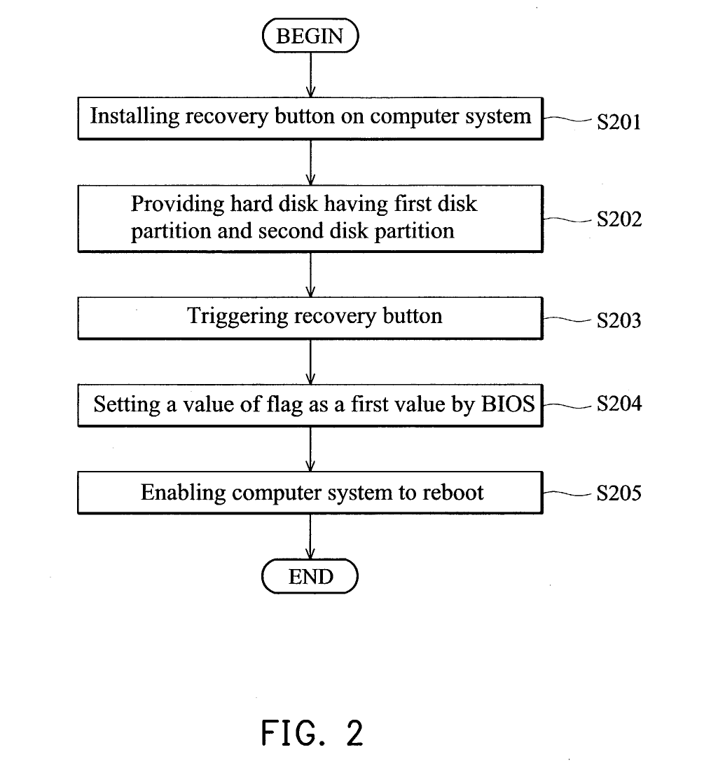

FIG. 2 shows the trigger process of the method of operating system recovery according to the first embodiment of the present invention. First, in step S201, the recovery button 1400 being operable through the GPIO interface is installed on the computer system 1000. Then, in step S202, the hard disk 1200 having the first disk partition 1220 and the second disk partition 1230 is provided in the computer system 1000. Similarly, the first disk partition 1220 includes an original copy of the operating system 1221, and the second disk partition 1230 includes the recovery system 1231 and an image file 1232 which is am image copy of the operating system 1221, in which the second disk partition 1230 is unrecognizable to the operating system 1221.

When users want to perform operating system recovery, in step S203, users may trigger the recovery button 1400. Afterward, in step S204, the BIOS 1100 of the computer system 1000 sets a value of the flag 1300 as a first value, such as binary 1 in response to the trigger of the recovery button 1400, and in step S205, the BIOS 1100 enables the computer system 1000 to reboot.

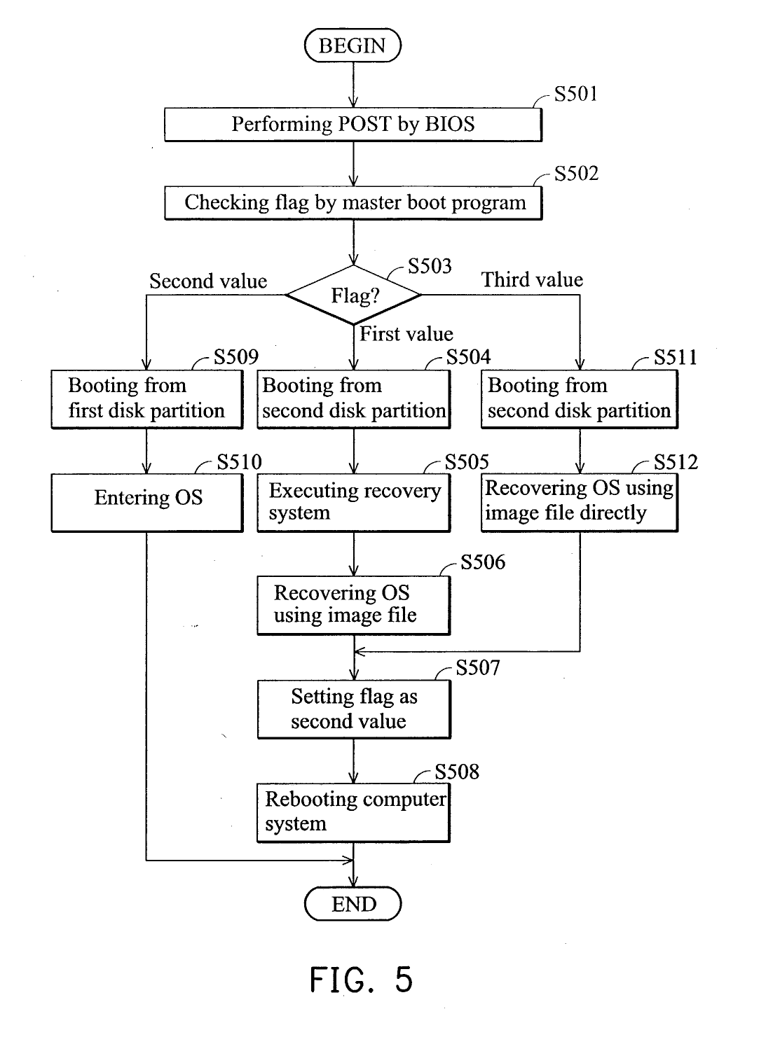

FIG. 5 shows the boot process according to the present invention. When the computer system 1000 reboots, in step S501, the BIOS 1100 of the computer system 1000 performs POST (Power On self Test) operations. Then, in steps S502 and S503, the master boot program within the MBR 1210 checks the value of the flag 1300. It should be noted that specific interrupt instructions destined for accessing (read and write) the flag 1300 can be defined in the BIOS 1100 in advance, and the access of the flag 1300 can be accomplished by calling the specific interrupt instructions.

At this time, since the value of the flag 1300 has been set as the first value in step S204, in step S504, the computer system 1000 boots to the second disk partition 1230, and in step S505, the recovery system 1231 in the second disk partition 1230 is executed. Thereafter, in step S506, the operating system 1221 in the first disk partition 1220 is recovered by the image file 1232 in the second disk partition 1230. Afterward, in step S507, the value of the flag 1300 is set as a second value, such as binary 0, and in step S508, the computer system 1000 is enabled to reboot.

When the computer system 1000 reboots again, in steps S501 to S503, the computer system 1000 performs POST operations and checks the value of the flag 1300. Since the value of the flag is set as the second value, in step S509, the computer system 1000 boots to the first disk partition 1220, and in step S510, the operating system 1221 is executed. It should be noted that the computer system 100 will proceed to the normal boot process if the,value of the flag 1300 is set as the second value. The steps S511 and S512 in FIG. 5 will be discussed later in a second embodiment.

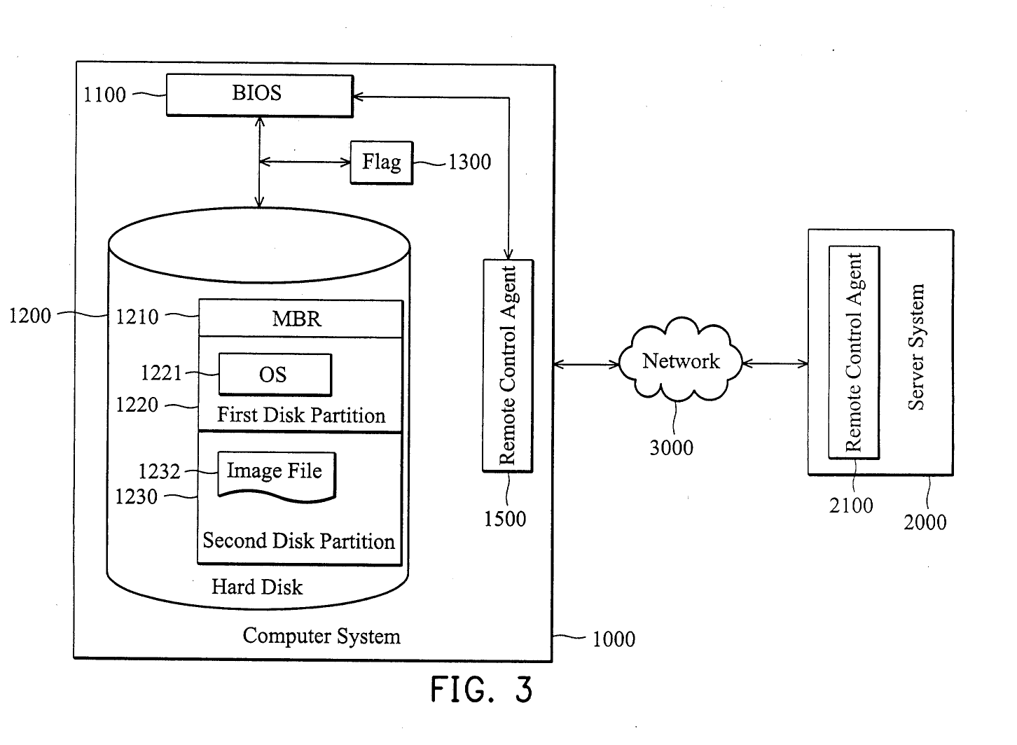

FIG. 3 illustrates the architecture of the system of operating system recovery according to a second embodiment of the present invention. The second embodiment of the present invention allows users to recover the operating system of a computer system by a remote server system through a network. The system of operating system recovery is suitable for use in a computer system 1000 coupled with a server system 2000 through a network 3000.

The server system 2000 can be installed with a remote control agent 2100, such as the LDCM (LanDesk Client Manager) program from Intel. The server system 2000 may use the remote control agent 2100 to monitor or transmit information to the computer system 1000 through the network 3000, in which the network 3000 may be Intranet, LAN (Local Area Network), WAN (Wide Area Network), and/or Internet.

The computer system 1000 has similar components to those described in the first embodiment, in which the same components are labeled with the same number. The computer system 1000 includes a BIOS 1100, a hard disk 1200, a flag 1300 and a remote control agent 1500.

The hard disk 1200 includes a MBR (Master Boot Record) 1210, a first disk partition 1220 and a second disk partition 1230. The first disk partition 1220 is the default bootable partition of the computer system 1000. The first disk partition 1220 includes an original copy of the operating system 1221. The second disk partition 1230 is an unknown partition to the operating system 1221, and the second disk partition 1230 includes an image file 1232 which is an image copy of the operating system 1221. The image file 1232 can be used to recover the operating system 1221 in the first disk partition 1220.

Similarly, the flag 1300 may be implemented by hardware or implemented using software. The flag 1300 is used to store a booting mode of the computer system 1000. The remote control agent 1500 receives the information or instructions from the remote control agent 2100 of the server system 2000.

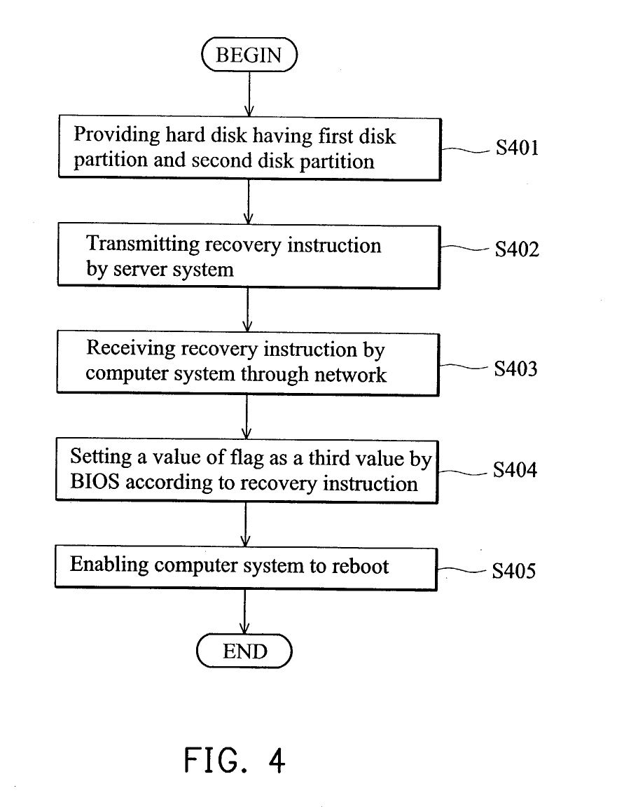

FIG. 4 shows the trigger process of the method of operating system recovery according to the second embodiment of the present invention. First, in step S401, the hard disk 1200 having the first disk partition 1220 and the second disk partition 1230 is provided in the computer system 1000. Similarly, the first disk partition 1220 includes an original copy of the operating system 1221, and the second disk partition 1230 includes an image file 1232 which is an image copy of the operating system 1221.

To perform operating system recovery, in step S402, the server system 200 uses the remote control agent 2100 to transmit a recovery instruction. It should be noted that a user interface can be designed for use in the server system 2000, and users can select a specific computer system for remote recovery through the user interface.

Then, in step S403, the remote control agent 1500 of the computer system 1000 receives the recovery instruction from the server system 200 through the network 3000. Thereafter, in step S404, the computer system 1000 enables the BIOS 1100 to set the value of the flag 1300 as a third value, such as binary 2 in response to the recovery instruction, and in step S405, the BIOS 1100 enables the computer system 1000 to reboot.

Referring to FIG. 5 again, in step S501, the BIOS 1100 of the computer system 1000 performs POST operations. Then, in steps S502 and S503, the MBR 1210 checks the value of the flag 1300. At this time, since the value of the flag 1300 has been set as the third value in step S404, in step S511, the computer system 1000 boots to the second disk partition 1230, and in step S512, the operating system 1221 in the first disk partition 1220 is recovered using the image file 1232 in the second disk partition 1230 directly. Afterward, in step S507, the value of the flag 1300 is set as the second value, and in step S508, the computer system 1000 is enabled to reboot.

When the computer system 1000 reboots again, in steps S501 to step S503, the computer system 1000 performs POST operations and checks the value of the flag 1300. Since the value of the flag is set as the second value, in step S509, the computer system 1000 boots from the first disk partition 1220, and in step S510, the operating system 1221 is executed.

As a result, by using the method and system of operating system recovery according to the present invention, the operating system of a computer system can be recovered by local operations or a remote server system through a network. Thus the computer system can be recovered without the system disc and recovery disc so as to improve the efficiency of system recovery and save resources expended during production.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A system of operating system recovery, comprising:
a computer system, comprising;
a basic input/output system;
a hard disk having a first disk partition and a second disk partition, in which the first disk partition has an original copy of an operating system and the second disk partition has a recovery system and an image copy of the operating system; and
a recovery button installed on the computer system and operable through an input/output interface to enable the basic input/output system to reboot the computer system to the second disk partition, and execute the recovery system to recover the operating system in the first disk partition by the image copy of the operating system.

2. The system of operating system recovery as claimed in claim 1 wherein the input/output interface is implemented by a general purpose input/output pin.

3. The system of operating system recovery as claimed in claim 1 wherein the first disk partition is a default bootable partition.

4. The system of operating system recovery as claimed in claim 1 wherein the second disk partition is an unknown disk partition to the operation system in the computer.

5. The system of operating system recovery as claimed in claim 1 further comprising a flag to store a booting mode of the computer system.

6. The system of operating system recovery as claimed in claim 5 wherein the hard disk further includes a master boot record containing a master boot program, and wherein the master boot program is used to check a value of the flag and execute the recovery system in the second partition to recover the operating system in the first disk partition by the image copy of the operating system if the value of the flag is checked to match a specific value.

7. A method of operating system recovery in a computer system, comprising the steps of:
installing a recovery button implemented using a general purpose input/output interface on the computer system;
providing a hard disk having a first disk partition and a second disk partition, in which the first disk partition has an original copy of an operating system and the second disk partition has a recovery system and an image copy of the operating system; and
triggering the recovery button to reboot the computer system to the second disk partition, and execute the recovery system in the second disk partition to recover the operating system in the first disk partition by the image copy of the operating system.

8. The method of operating system recovery as claimed in claim 7 wherein the step of rebooting the computer system to the second disk partition comprising the steps of:
setting a value of a flag as a first value;
enabling the computer system to reboot;
checking the value of the flag by a master boot program within a master boot record; and
rebooting the computer system to the second disk partition if the flag is checked to match the first value.

9. The method of operating system recovery as claimed in claim 8 further comprising the steps of:
setting the value of the flag as a second value;
enabling the computer system to reboot;
check the value of the flag by a master boot program; and
rebooting the computer system to the first disk partition if the flag is checked to match the second value.

10. The method of operating system recovery as claimed in claim 7 wherein the first disk partition is a default boot partition.

11. The method of operating system recovery as claimed in claim 7 wherein the second disk partition is an unknown disk partition to the operating system in the computer system.

12. A system of operating system recovery, comprising:
a server system having a remote control agent to transmit a recovery instruction by the remote control agent; and
a computer system coupled to the server system through a network, comprising;
a basic input/output system; and
a hard disk having a first disk partition and a second disk partition, in which the first disk partition has an original copy of an operating system and the second disk partition has an image copy of the operating system,
wherein the computer system is allowable to receive the recovery instruction and reboots to the second disk partition and recovers the operating system in the first disk partition by the image copy of the operating system.

13. The system of operating system recovery as claimed in claim 12 wherein the first disk partition is a default bootable partition.

14. The system of operating system recovery as claimed in claim 12 wherein the second disk partition is an unknown disk partition to the operation system in the computer.

15. The system of operating system recovery as claimed in claim 12 further comprising a flag to store a booting mode of the computer system.

16. The system of operating system recovery as claimed in claim 15 wherein the hard disk further includes a master boot record containing a master boot program, and wherein the master boot program is used to check a value of the flag and recover the operating system in the first disk partition by the image copy of the operating system if the value of the flag is checked to match a specific value.

17. The system of operating system recovery as claimed in claim 16 wherein the value of the flag is set and checked by calling an interrupt.

18. A method of operating system recovery in a computer system coupled with a server system through a network, comprising the steps of:
providing a hard disk having a first disk partition and a second disk partition in the computer system, in which the first disk partition has an original copy of an operating system and the second disk partition has an image copy of the operating system;
transmitting a recovery instruction by a remote control agent of the server system;
receiving the recovery instruction by the computer system through the network; and
instructing a BIOS to reboot the computer system to the second disk partition in response to the recovery instruction, and recovering the operating system in the first disk partition by the image copy of the operating system.

19. The method of operating system recovery as claimed in claim 18 wherein the step of instructing the BIOS to reboot the computer system to the second partition and recovering the operating system in the first disk partition by the image copy of the operating system further comprising the steps of:
setting a value of a flag as a third value;
enabling the computer system to reboot;
checking the flag by a master boot program within a master boot record; and
rebooting the computer system from to second disk partition and recovering the operating system in the first disk partition by the image copy of the operating system if the value of the flag is checked to match the third value.

20. The method of operating system recovery as claimed in claim 19 further comprising the steps of:
setting the value of the flag as a second value;
enabling the computer system to reboot;
checking the value of the flag by a master boot program; and
rebooting the computer system to the first disk partition if the flag is checked to match the second value.
